(19) United States
(12) Patent Application Publication
(10) Pub. No.: US 2010/0062114 A1
(43) Pub. Date: Mar. 11, 2010

(54) NUTRACEUTICAL COMPOSITION FOR IMPROVING FOOTPAD & COAT AND SKIN QUALITY IN PETS

(75) Inventors: Stephanie J.M. KRAMMER-LUKAS, Lorrach (DE); Piotr JANOWICZ, Breda (NL); Krisztina KUNGL, Budapest (HU)

Correspondence Address: NIXON & VANDERHYE, PC, 901 NORTH GLEBE ROAD, 11TH FLOOR, ARLINGTON, VA, 22203, US

(73) Assignee: DSM IP ASSETS B.V., Heerlen (NL)

(21) Appl. No.: 12/619,590

(22) Filed: Nov. 16, 2009

Related U.S. Application Data
(63) Continuation of application No. 11/988,642.
Application No. 11/988,642 is a continuation of application No. PCT/EP2006/006573, filed on Jul. 6, 2006.

(30) Foreign Application Priority Data
Jul. 12, 2005 (EP) 05015043.2

(51) Int. Cl. A23L 1/30

(52) U.S. Cl. 426/72

(57) ABSTRACT

A composition, useful in preventing and/or treating of footpad & coat and skin damages in pets and/or of stimulating the keratinisation process, wherein said composition comprises: (a) biotin and (b) at least one poly-unsaturated fatty acid. The compositions are of primary interest for use in dog and cat food.

This application is a continuation of commonly owned co-pending U.S. application Ser. No. 11/988,642, filed Jan. 11, 2008, which in turn is the national phase application under 35 USC §371 of PCT/EP2006/006573, filed Jul. 6, 2006, which designated the U.S. and claims priority to European Patent Application No. 05015043.2, filed Jul. 12, 2005, the entire contents of each of which are hereby incorporated by reference.

The present invention refers to a nutraceutical composition for improving footpad & coat and skin quality in pets in the form of a dietary composition such as fortified foods including treats, supplements for food and foodstuff, or in the form of galenical formulations such as tablets.

Skin is a very complex dynamic organ. It is responsible for many precisely controlled functions in the body and is influences by a wide range of nutrients. The physical-mechanical support of the skin reflects its importance in keeping all internal organs safely isolated from the environment. It is the first body system to come into physical contact with the environment. One particular aspect of this barrier function is the special anatomical construction of the feet, particularly when thy have a dedicated structure such as is the case with the foot pads in dogs and cats. These structures allow for safe and comfortable roaming, walking and running. In more aggressive contacts; for example in a fight amongst cats or the digging behaviour in dogs, claws which are actually a further specialist development of skin play their role.

Foot pads and claws quite naturally during the normal process of life become damaged and worn. Because of this constant use damage and abrasion there has developed natural protective physiologically support in the form of constant growth and differentiation of epidermis cells (keratinisation). This process can be hindered by inadequate nutrition and optimized by appropriate supportive nutrition.

The keratinisation process is related to the epidermis, the outer layer of the skin. In the keratinisation process epidermis cells differentiate. They develop in the deep part of the epidermis and shift upwards towards the surface. Finally cells lose their organelles and die, but remain rich of mechanically important keratin, whilst becoming thin and compacted. Over the time of the differentiation process cells form granules, where other important components are produced, for example fillagrin, intercellular lipids and hydrolytic enzymes.

It has now been found that compositions containing biotin in combination with LC-poly-unsaturated fatty acids, so called PUFA's, have a significant additive and synergistic effect in preventing and treating of footpad & coat and skin damages in pets and of stimulating the keratinisation process.

Biotin can occur in eight different stereoisomeric forms and is a known active ingredient, which can be found in numerous pharmaceutical compositions. In accordance with the invention it has further been found that biotin is a key component in the process of keratin synthesis as well as in lipogenetic pathway. In addition it is suggested that biotin supports the cell proliferation and differentiation processes within the epidermis which again is important for successful keratinisation. Furthermore, preliminary animal studies showed that the combination of biotin with LC-poly-unsaturated fatty acids results in a most noticeable improvement of skin, coat and food quality in pets.

The present invention is defined in the claims. The present invention specifically refers to a nutraceutical composition, characterized in that said composition comprises biotin and at least one poly-unsaturated fatty acid.

Said composition may be provided in the form of a concentrate, for example as a simple powdery mixture of its components; or in the form of granules as are obtained for example by spray drying an aqueous slurry of the components or by extruding the mixture; or in the form of tablets as are obtained by compressing the powder into tablets with conventional tabletting methods and machinery.

In yet another aspect, the present invention relates to the use of a combination of biotin and at least one poly-unsaturated fatty acid for the manufacture of a composition for preventing and/or treating of footpad & coat and skin damages in pets and of stimulating the keratinisation process.

The present invention further refers to a method of preventing or treating of footpad & coat and skin damages in pets and of stimulating the keratinisation process in pets which comprises administering to a pet an effective amount of said composition.

Advantageous embodiments of the invention become evident from the dependent claims.

The term nutraceutical as used herein denotes a usefulness in both the nutritional and pharmaceutical field of application. Thus, the novel nutraceutical compositions can find use as supplement to food and as pharmaceutical formulations for parenteral application which may be solid formulations such as capsules or tablets, or liquid formulations, such as solutions or suspensions. As will be evident from the foregoing, the term nutraceutical composition also comprises supplement compositions containing the aforesaid active ingredients (Inventive Ingredients) as well as food and foodstuff including premixes used therefore, especially for pets, which contain the mixture of Inventive Ingredients.

Poly-unsaturated fatty acids (PUFA's) are known per se. Preferred poly-unsaturated fatty acids are those having from 16 to 24 carbon atoms, preferably from 18 to 22 carbon atoms, preferably with 18, 20 or 22 carbon atoms and having multiple unsaturated carbon-carbon double bonds.

Examples of such poly-unsaturated fatty acids are the known n-3 PUFA's. Preferred are for example poly-unsaturated acids such as n-3 PUFA, mainly as eicosapentaenoic acid docosapentaenoic acid, docosahexaenoic acid, such as (cis-)5,8,11,14,17-eicosapentanoic acid and/or (cis-)4,7,10,13,16,19-docosahexaenic acid.

The nutraceutical composition of the present invention contains biotin in an amount sufficient to administer to a subject a dosage from about 0.01 mg to about 3 mg per kg body weight per day, preferably from about 0.1 mg to about 0.5 mg per kg body weight per day. Thus, if the nutraceutical composition is a food the amount of biotin contained therein is suitably in the range from about 0.03 mg per serving to about 50 mg per serving. If the nutraceutical composition is a pharmaceutical formulation such formulation may contain from about 0.35 mg to about 200 mg per solid dosage unit, e.g., per tablet, or a corresponding dosage in a liquid formulation, or from about 0.35 mg per daily dose to about 200 mg per daily dose.

Preferably the composition contains the poly-unsaturated fatty acid in a concentration so that the daily consumption is in the range of from 4 mg to 120 mg. Preferably the composition contains per one milligram of biotin [component (a)] about 5 mg to 200 mg, preferably about 20 mg to 50 mg, of poly-unsaturated fatty acid [component (b)].

Biotin and PUFA may be incorporated into conventional pet food e.g., into dry pet food by spraying a solution, for example an aqueous solution containing the Inventive Ingredients on the food composition while thoroughly mixing the composition, or by adding the Inventive Ingredients to the dough. Inventive Ingredients may be added simultaneously, e.g. at the same time and even as a premix, or consecutively as single Inventive Ingredient at a time or as a premix. Premixes may also include one or more of the other components of the final composition.

Examples of pets include dogs, cats and rodents, e.g., chinchillas, guinea pigs, degus, mice, gerbils, hamsters, rats, ferrets and lagomorphes, e.g., rabbits. Animals of all ages are included, e.g. young, adults, animals of medium age and seniors. The compositions and method of treatment are of primary interest for use in food for dogs and cats.

The pet food according to the present invention may be based on any conventional pet food. There is a wide range of pet foods available which may be grouped into (a) complete diets, (b) complementary diets, and (c) snacks and treats. Complete diets may be fed in addition to water for an extended period as the sole source of nutrients and will provide for all the energetic and nutrient needs of the animal and the physiological state for which it is intended. Complementary diets normally are not sufficient to ensure that all nutrient and energy requirements are met unless fed in combination with another foodstuff or diet. Snacks and treats are appetizers or for occasional feeding and are considered as complementary products. There are, however, a number of products available intended to form part of the daily diet or playing a role in animal well-being.

The pet food of the present invention may be in a dry, canned, semi-moist or baked form. Typical components of such compositions, in addition to Inventive Ingredients, are crude protein, crude fat, carbohydrates (NfE), starch, crude fibers, and ash, further on minerals, trace elements, vitamins, fatty acids, protein and amino acids, choline, camitin, dietary fiber and substances required for balanced diets of the different animal species. Basic ingredients of such food compositions are
Crude Protein including proteins and N-containing compounds of non-proteinaceous nature, e.g. acid amides, amines, free amino acids, ammonium salts, alkaloids;
Crude Fat including neutral fats, lipoids (phospho-, sphingolipids, steroids) and other ethersoluble compounds;
N-free Extractions (NFE) including polysaccharides (starch, glycogen), soluble saccharides (glucose, fructose, saccharose, lactose, maltose and oligosaccharides), and soluble fractions of cellulose, hemicellulose, lignin and pectines;
Crude Fibers including insoluble fractions of cellulose, hemicellulose, lignin and other components of the cell wall like suberin, cutin etc.;
Ash including minerals (macrominerals such as calcium, phosphorus, sodium, chloride, potassium, magnesium, and microminerals, i.e., trace elements, such as iron, copper manganese, zinc, iodine, selenium,) and further inorganic substances e.g. silicate.
Vitamins including vitamins A, B1, B2, B6, B12, D, pantothenic acid, niacin, folic acid, linolic acid and choline.

Further components may, e.g. L-carnitine, chondroitin sulfate, glucosamine, glutamine/glutamic acid, arginine, taurine and hydroxyproline.

Typical components which provide the ingredients for a dog food composition, in addition to Inventive Ingredients, comprise, e.g., chicken/beef/turkey, liver, broken pearl barley, ground corn, brute fat, whole dried egg, fowl protein hydrolyzate, vegetable oil, calcium carbonate, choline chloride, potassium chloride, iodinized salt, iron oxide, zinc oxide, copper sulfate, manganese oxide, sodium selenite, calcium iodate, provitamin D, vitamin B1, niacin, calcium panthothenate, pyridoxin hydrochloride, riboflavin, folic acid, vitamin B12.

Typical components which provide the ingredients for a cat food composition, in addition to Inventive Ingredients, comprise beef, chicken meat, dried chicken liver, lamb meat, lamb liver, pork, turkey meat, turkey liver, poultry meal, fish meal, fowl protein hydrolysate, animal fats, plant oils, soy bean meal, pea bran, maize gluten, whole dry egg, ground corn, corn flour, rice, rice flour, dry sugar beet molasses, fructooligosaccharides, soluble fibres, plant gums, cellulose powder, clay, bakers yeast, iodized sodium chloride, calcium sulfate, sodium triphosphate, dicalcium phosphate, calcium carbonate, potassium chloride, choline chloride, magnesium oxide, zinc oxide, iron oxide, copper sulfate, iron sulfate, manganese oxide, calcium jodate, sodium selenite, provitamin D, thiamine, niacin, calcium pantothenate, pyridoxine hydrochloride, riboflavin, folic acid, vitamin B12, taurin, L-carnitine, caseine, D-methionine.

Wet pet food contains between about 70 and about 85% moisture and about 15 and about 25% dry matter.

A typical wet food for adult dogs may, e.g. comprise, in addition to Inventive Ingredients, at minimum 24% protein, 15% fat, 52% starch, 0.8% fibre, 3% linolic acid, 0.6% calcium, 0.5% phosphorus, the Ca:P ratio being 1:1, 0.2% potassium, 0.6% sodium, 0.09% chloride, 0.09% magnesium, 170 mg/kg of iron, 15 mg/kg of copper, 70 mg/kg of manganese, 220 mg/kg of zinc, 4 mg/kg of iodine, 0.43 mg/kg of selenium, 74000 IU/kg of vitamin A, 1200 IU/kg of vitamin D, 11 mg/kg of vitamin B1, 6 mg/kg of riboflavin, 30 mg/kg of pantothenic acid, 20 mg/kg of niacin, 4.3 mg/kg of pyridoxine, 0.9 mg/kg of folic acid, 0.2 μg/kg of vitamin B12, 2500 mg/kg of choline, 2500 mg/kg cholin, all percentages being based on dry weight of the total food composition.

A typical wet food for adult cats may, e.g. comprise, in addition to Inventive Ingredients, at minimum 44% protein, 25% fat, 20% starch, 2.5% fibre, 0.8% calcium, 0.6% phosphorus, 0.8% potassium, 0.3% sodium, 0.09% chloride, 0.08% magnesium, 0.25% taurin, 170 mg/kg of iron, 15 mg/kg of copper, 70 mg/kg of manganese, 220 mg/kg of zinc, 4 mg/kg of iodine, 0.43 mg/kg of selenium, 74000 IU/kg of vitamin A, 1200 IU/kg of vitamin D, 11 mg/kg of vitamin B1, 6 mg/kg of riboflavin, 30 mg/kg of pantothenic acid, 20 mg/kg of niacin, 4.3 mg/kg of pyridoxine, 0.9 mg/kg of folic acid, 0.2 μg/kg of vitamin B12, 2500 mg/kg of choline, 2500 mg/kg cholin, all percentages being based on dry weight of the total food composition.

Dry pet food contains between about 6 and about 14% moisture and about 86% or more dry matter.

A typical dry food for adult dogs may, e.g. comprise, in addition to Inventive Ingredients, at minimum 25% protein, 12% fat, 41.5% starch, 2.5% fibre, 1% linolic acid, 1% calcium, 0.8% phosphorus, the Ca:P ratio being 1:1, 0.6% potassium, 0.35% sodium, 0.09% chloride, 0.1% magnesium, 170 mg/kg of iron, 35 mg/kg of copper, 70 mg/kg of manganese, 220 mg/kg of zinc, 4 mg/kg of iodine, 0.43 mg/kg of selenium, 15000 IU/kg of vitamin A, 1200 IU/kg of vitamin D, 11 mg/kg of vitamin B1, 6 mg/kg of riboflavin, 30 mg/kg of pantothenic acid, 20 mg/kg of niacin, 4.3 mg/kg of pyridoxine, 0.9 mg/kg of folic acid, 0.2 μg/kg of vitamin B12, 2500 mg/kg of choline, all percentages being based on dry weight of the total food composition.

A typical food for adult cats may, e.g. comprise, in addition to Inventive Ingredients, at minimum 32% protein, 15% fat, 27.5% starch, 11% dietetic fibres, 4.5% fibre, 3.4% linolic acid, 0.08% arachionic acid, 0.15% taurin, 50 mg/kg L-carnitin, omega 6/3=5, 1% calcium, 0.8% phosphorus, the Ca:P ratio being at least 1:1, 0.6% potassium, 0.4% sodium, 0.6% chloride, 0.08% magnesium, 190 mg/kg of iron, 30 mg/kg of copper, 60 mg/kg of manganese, 205 mg/kg of zinc, 2.5 mg/kg of iodine, 0.2 mg/kg of selenium, 25000 IU/kg of vitamin A, 1500 IU/kg of vitamin D, 20 mg/kg of vitamin B1, 40 mg/kg of riboflavin, 56 mg/kg of pantothenic acid, 153 mg/kg of niacin, 14 mg/kg of pyridoxine, 3.2 mg/kg of folic acid, 0.2 mg/kg of vitamin B12, 3000 mg/kg of choline, all percentages being based on dry weight of the total food composition.

Dry food may be prepared, e.g., by screw extrusion including cooking, shaping and cutting of raw ingredients into a specific kibble shape and size in a very short period of time, while simultaneously destroying detrimental micro-organisms. The ingredients may be mixed into homogenous expandable dough and cooked in an extruder (steam/pressure) and forced through a plate under pressure and high heat. After cooking, the kibbles are then allowed to cool, before optionally being sprayed with a coating which may include liquid fat or digest including liquid or powdered hydrolyzed forms of an animal tissue such as liver or intestine from, e.g., chicken or rabbit. Hot air drying then reduces the total moisture content to 10% or less.

Canned (wet) food may be prepared, e.g., by blending the raw ingredients including meats and vegetables, gelling agents, gravies, vitamins, minerals and water. The mix is then fed into cans on a production line, the lids are sealed on and the filled cans are sterilized at a temperature of about 130° C. for about 50 to 100 min.

The following examples illustrate the invention further.

### EXAMPLE 1

Commercial dry dog food (Hill's Science diet “Canine Maintenance dry” for dogs as supplied by Hill's Pet Nutrition GmbH, Liebigstrasse 2-20, D-22113) is sprayed with an aqueous solution of biotin and ROPUFA® (as supplied by DSM Nutritional Products) in an amount sufficient to administer to a subject a daily dose of 0.1 mg to 3 mg biotin and 4 mg to 120 mg ROPUFA per kg body weight. Further Vitamin C and E and β-carotene are incorporated in an amount sufficient to provide 30 mg vitamin C/kg, and 300 IU vitamin E/kg and 280 mg β-carotene/kg in the final food composition before extruding the entire blend. The food composition is dried to contain dry matter of about 90% by weight.

### EXAMPLE 2

Commercial wet dog food (Hill's Science diet “Canine Maintenance wet” for dogs as supplied by Hill's Pet Nutrition GmbH, Liebigstrasse 2-20, 22113 Hamburg, Germany) is mixed with an aqueous solution of biotin and ROPUFA® (as supplied by DSM Nutritional Products) in an amount sufficient to administer to a subject a daily dose of 0.1 mg to 3 mg biotin and 4 mg to 120 mg ROPUFA per kg body weight. Further Vitamin C and E and β-carotene are incorporated in an amount sufficient to provide 30 mg vitamin C/kg, and 300 IU vitamin E/kg and 280 mg β-carotene/kg in the final food composition before cooking the entire blend. The food composition is dried to contain a dry matter of about 90% by weight.

### EXAMPLE 3

Commercial dog treats (Mera Dog “Biscuit” for dogs as supplied by Mera Tiernahrung GmbH, Marienstrasse 80-84, 47625 Kevelaer-Wetten, Germany) are sprayed with an aqueous solution of biotin and ROPUFA® (as supplied by DSM Nutritional Products) in an amount sufficient to administer to a subject a daily dose of 0.1 mg to 3 mg biotin and 4 mg to 120 mg ROPUFA per kg body weight. Further Vitamin C and E and β-carotene are incorporated in an amount sufficient to provide 30 mg vitamin C/kg, and 300 IU vitamin E/kg and 280 mg β-carotene/kg in the final food composition before extruding the entire blend. The food composition is dried to contain a dry matter of about 90% by weight.

### EXAMPLE 4

Commercial dry cat food (Hill's Science diet “Feline Maintenance dry” for cats as supplied by Hill's Pet Nutrition GmbH, Liebigstrasse 2-20, D-22113) is sprayed with an aqueous solution of biotin and ROPUFA® (as supplied by DSM Nutritional Products) in an amount sufficient to administer to a subject a daily dose of 0.1 mg to 3 mg biotin and 4 mg to 120 mg ROPUFA per kg body weight. Further Vitamin C and E and β-carotene arc incorporated in an amount sufficient to provide 30 mg vitamin C/kg, and 300 IU vitamin E/kg and 280 mg β-carotene/kg in the final food composition before extruding the entire blend. The food composition is dried to contain a dry matter of about 90% by weight.

### EXAMPLE 5

Commercial wet cat food (Hill's Science diet “Feline Maintenance wet” for cats as supplied by Hill's Pet Nutrition GmbH, Liebigstrasse 2-20, D-22113) is sprayed with an aqueous solution of biotin and ROPUFA® (as supplied by DSM Nutritional Products) in an amount sufficient to administer to a subject a daily dose of 0.1 mg to 3 mg biotin and 4 mg to 120 mg ROPUFA per kg body weight. Further Vitamin C and E and β-carotene are incorporated in an amount sufficient to provide 30 mg vitamin C/kg, and 300 IU vitamin E/kg and 280 mg β-carotene/kg in the final food composition before cooking the entire blend. The food composition is dried to contain a dry matter of about 90% by weight.

### EXAMPLE 6

Commercial cat treats (Whiskas Dentabits for cats as supplied by Whiskas, Masterfoods GmbH, Eitzer Str. 215, 27283 Verdert/Aller, Germany) are sprayed with an aqueous solution of biotin and ROPUFA® (as supplied by DSM Nutritional Products) in an amount sufficient to administer to a subject a daily dose of 0.1 mg to 3 mg biotin and 4 mg to 120 mg ROPUFA per kg body weight. Further Vitamin C and E and β-carotene are incorporated in an amount sufficient to provide 30 mg vitamin C/kg, and 300 IU vitamin E/kg and 280 mg β-carotene/kg in the final food composition before extruding the entire blend. The food composition is dried to contain a dry matter of about 90% by weight.

### Experimental Section

In the following experimental section histological and microscopic analysis were used to allow quantification of subjective impression.

3 groups of 6 dogs (three different breeds, Beagles, Labrador Retrievers and Wirehaired Dachshunds) in the age of 4-7 years were made available for the feeding study, being assigned either to a control group or a study group. At the beginning of the trial, which was conducted over a period of 28 days, the health status of the dogs was examined using various indices and tests including the subjective evaluation of skin & coat (gloss, uniformity, softness, dander/scaling, overall quality) according to Davenport & Reinhart (IV Vet. Dermatology Congress, 2000, San Francisco, USA). In addition, blood samples were taken to determine the health status of the animal.

Over the following 12 weeks, the control group was given a commercial diet characterized by the following content

| Commercial diet | Units | Content |
|---|---|---|
| Moisture | % | 10.38 |
| Protein | % | 15.11 |
| Fat | % | 6.0 |
| Ash | % | 7.52 |
| Crude Fibre | % | 2.29 |

Over the same period the study group was given said commercial diet containing in addition the ingredients biotin and at least one poly-unsaturated fatty acid according to the indication below.
5 mg of Rovimix® (D-Biotin composition, DSM Nutritional Products AG, CH Basel) per 10 kg bodyweight

=>0.8-1.1. mg biotin per 100 kcal of Metaboliosation and
ROPUFA® (n-3 Food Oil composition 1, DSM Nutritional Products AG, CH Basel) with an overall ration of n-6 to n-3 fatty acids of 5:1

=>45.4 mg of docosahexaenoic acid (DHA; 22:6n-3) per 100 kcal of Metabolisation.

At day 28 and at the end of the trial the dogs were examined again, and all the evaluations carried out at the start of the trial were repeated.

From the experimental data one can conclude that the combined intake of biotin and n-3 PUFA's surprisingly have a significant long-term effect for improving footpad & coat and skin quality in pets.

In particular regarding the skin quality:
The keratinisation processes were found to be enhanced and stabilized.
The keratinisation zone was clearly marked and in tight contact with the keratinized layer.

Numerous mitotic divisions observed in the germinal layer of the epidermis indicating an intense renewal of the epidermis.

In the zone of dermis, adjoining the basal membrane of the epidermis, near capillary blood vessels were noted.

In particular regarding the hair quality:
The keratinisation process was more pronounced, which was especially visible in the internal sheath.
Tight adjoining of the hair sheath and tunicle of the inner hair sheath was observed.
An active state of sebaceous glands, accumulation of secretion granules in the cells of secretory zone of these glands and higher activity of apocrin sweat glands was observed.
The supplementation with the combination of Biotin and Ropufa resulted in clearly noticeable improvements of the coat quality.
SEM pictures reveal smoother hair surface and less dandruff formation after supplementation

In particular regarding foot pads quality:
Visual inspection of food pads show clearly improved quality of food pad surface after combined supplementation with Biotin and Ropufa.
Microscopic images reveal improvements in shedding process and surface homogeneity.

1. A nutraceutical composition, characterized in that said composition comprises
(a) biotin and
(b) at least one poly-unsaturated fatty acid.

2. A composition according to claim 1, characterized in that component (b) is a polyunsaturated fatty acid with 16 to 24 carbon atoms, preferably with 18 to 22 carbon atoms, preferably with 18, 20 or 22 carbon atoms, containing multiple unsaturated carbon-carbon double bonds.

3. A composition according to claim 1, characterized in that component (b) is an n-3 poly-unsaturated fatty acid.

4. A composition according to claim 1, characterized in that component (b) is selected from eicosapentaenoic acid, docosapentaenoic acid and docosahexaenoic acid.

5. A composition according to claim 1, characterized in that component (b) is selected from (cis-)5,8,11,14,17-eicosapentanoic acid and (cis-) 4,7,10,13,16,19-docosahexaenic acid.

6. A composition according to claim 1, characterized in that the composition contains biotin in a concentration so that the daily consumption is in the range of from 0.1 mg to 3 mg, preferably 0.1 mg to 0.5 mg per kg body weight.

7. A composition according to claim 1, characterized in that the composition contains the poly-unsaturated fatty acid in a concentration so that the daily consumption is in the range of from 4 mg to 120 mg per kg body weight.

8. A composition according to claim 1, characterized in that the composition contains per one milligram of biotin about 5 mg to 200 mg, preferably about 20 mg to 50 mg, of poly-unsaturated fatty acid.

9. A composition as in claim 1, which is a pet food or a supplement composition for a pet food, particularly for dogs or cats.

10. A composition as in claim 1, which is a galenical form, preferably a tablet,

11. The composition of biotin and at least one poly-unsaturated fatty acid for the manufacture of a composition for preventing and/or treating of footpad & coat and skin damages in pets and/or of stimulating the keratinisation process.

12. The composition as in claim 11, wherein said biotin being used in an amount sufficient to provide a daily dosage of 0.1 mg to about 3 mg per kg body weight and the at least one poly-unsaturated fatty acid being used in an amount sufficient to provide a daily dosage of 4 mg to about 120 mg per kg body weight.

13. The composition as in claim 11 in the manufacture of a dog food.

14. A method of preventing and/or treating of footpad & coat and skin damages in pets and/or of stimulating the keratinisation process which comprises administering to a pet an effective amount of a composition according to claim 1.

15. A method as in claim 14 wherein the pet is a dog or cat.

16. A method as in claim 14, wherein from about 0.1 mg to about 3 mg of biotin per kg body weight per day is administered.

17. A method as in claim 14, wherein from about 4 mg to about 120 mg of the at least one poly-unsaturated fatty acid per kg body weight per day is administered.
